(19) United States
(12) Patent Application Publication
(10) Pub. No.: US 2007/0294565 A1
(43) Pub. Date: Dec. 20, 2007

(54) Simplified parity disk generation in a redundant array of inexpensive disks

(75) Inventors: Craig Anthony Johnston, Sunnyvale, CA (US); Roger Keith Stager, Sunnyvale, CA (US); Pawan Saxena, Sunnyvale, CA (US)

Correspondence Address: VOLPE AND KOENIG, P.C. NET APP, 30 S. 17TH STREET, UNITED PLAZA, SUITE 1600, PHILADELPHIA, PA, 19103, US

(73) Assignee: Network Appliance, Inc., Sunnyvale, CA (US)

(21) Appl. No.: 11/413,325

(22) Filed: Apr. 28, 2006

(51) Int. Cl. G06F 11/00

(52) U.S. Cl. 714/6

(57) ABSTRACT

A method for efficiently writing data to a redundant array of inexpensive disks (RAID) includes: writing an entire slice to the RAID at one time, wherein a slice is a portion of the data to be written to each disk in the RAID; and maintaining information in the RAID for slices that have been written to disk. A system for efficiently writing data to a RAID includes a buffer, a parity generating device, transfer means, and a metadata portion in the RAID. The buffer receives data from a host and accumulates data until a complete slice is accumulated. The parity generating device reads data from the buffer and generates parity based on the read data. The transfer means transfers data from the buffer and the generated parity to the disks of the RAID. The metadata portion is configured to store information for slices that have been written to disk.

### FIELD OF INVENTION

The present invention relates generally to a redundant array of inexpensive disks (RAID), and more particularly, to a method for simplified parity disk generation in a RAID system.

### BACKGROUND

Virtual Tape Library

A Virtual Tape Library (VTL) provides a user with the benefits of disk-to-disk backup (speed and reliability) without having to invest in a new backup software solution. The VTL appears to the backup host to be some number of tape drives; an example of a VTL system 100 is shown in FIG. 1. The VTL system 100 includes a backup host 102, a storage area network 104, a VTL 106 having a plurality of virtual tape drives 108, and a plurality of disks 110. When the backup host 102 writes data to a virtual tape drive 108, the VTL 106 stores the data on the attached disks 110. Information about the size of each write (i.e., record length) and tape file marks are recorded as well, so that the data can be returned to the user as a real tape drive would.

The data is stored sequentially on the disks 110 to further increase performance by avoiding seek time. Space on the disk is given to the individual data “streams” in large contiguous sections referred to as allocation units. Each allocation unit is approximately one gigabyte (1 GB) in length. As each allocation unit is filled, load balancing logic selects the best disk 110 from which to assign the next allocation unit. Objects in the VTL 106 called data maps (DMaps) keep track of the sequence of allocation units assigned to each stream. Another object, called a Virtual Tape Volume (VIV), records the record lengths and file marks as well as the amount of user data.

There is a performance benefit to using large writes when writing to disk. To realize this benefit, the VTL 106 stores the data in memory until enough data is available to issue a large write. An example of VTL memory buffering is shown in FIG. 2. A virtual tape drive 108 in the VTL 106 receives a stream of incoming data, which is transferred into a buffer 202 by DMA. DMA stands for Direct Memory Access, where the data is transferred to memory by hardware without involving the CPU. In this case, the DMA engine on the front end Fibre Channel host adapter puts the incoming user data directly into the memory assigned for that purpose. Filled buffers 204 are held until there are a sufficient number to write to the disk 110. The buffer 202 and the filled buffers 204 are each 128 KB in length, and are both part of a circular buffer 206. Incoming data is transferred directly into the circular buffer 206 by DMA and the data is transferred out to the disk 110 by DMA once enough buffers 204 are filled to perform the write operation. A preferred implementation transfers four to eight buffers per disk write, or 512 KB to 1 MB per write.

RAID4

RAID (redundant array of inexpensive disks) is a method of improving fault tolerance and performance of disks. RAID4 is a form of RAID where the data is striped across multiple data disks to improve performance, and an additional parity disk is used for error detection and recovery from a single disk failure.

A generic RAID4 initializes the parity disk when the RAID is first created. This operation can take several hours, due to the slow nature of the read-modify-write process (read data disks, modify parity, write parity to disk) used to initialize the parity disk and to keep the parity disk in sync with the data disks.

RAID4 striping is shown in FIG. 3. A RAID 300 includes a plurality of data disks 302, 304, 306, 308, and a parity disk 310. The lettered portion of each disk 302-308 (e.g., A, B, C, D) is a “stripe.” To the user of the RAID 300, the RAID 300 appears as a single logical disk with the stripes laid out consecutively (A, B, C, etc.). A stripe can be any size, but generally is some small multiple of the disk's block size. In addition to the stripe size, a RAID4 system has a stripe width, which is another way of referring to the number of data disks, and a “slice size”, which is the product of the stripe size and the stripe width. A slice 320 consists of a data stripe at the same offset on each disk in the RAID and the associated parity stripe.

Performance is improved because each disk only has to record a fraction (in this case, one fourth of the data. However, the time required to update and write the party disk decrease performance. Therefore, a more efficient way to update the parity disk is needed.

Exclusive OR Parity

Parity in a RAID4 system is generated by combining the data on the data disks using exclusive OR (XOR) operations. Exclusive OR can be thought of as addition, but with the interesting attribute that if A XOR B=C then C XOR B=A, so it is a little like alternating addition and subtraction (see Table 1; compare the first and last columns).

TABLE 1
Forward and reverse nature of XOR operation

| A | B | A\hat{ }B = C | C \hat{ } B |
|---|---|---|---|
| 0 | 0 | 0 | 0 |
| 0 | 1 | 1 | 0 |
| 1 | 0 | 1 | 1 |
| 1 | 1 | 0 | 1 |

Exclusive OR is a Boolean operator, returning true (1) if one or the other of the values being operated on are true and returning false (0) if neither or both of those values are true. In the following discussion, the caret symbol (‘ˆ’) will be used to indicate an XOR operation.

If more than two operators are being acted on, XOR is associative, so AˆBˆC=(AˆB)ˆAˆ(BˆC), as shown in Table 2. Notice also that the final result is true when A, B, and C have an odd number of is between them; this form of parity is also referred to as odd parity.

TABLE 2
Associative property of XOR operation

| A | B | C | (A\hat{ }B) | (A\hat{ }B)\hat{ }C |
|---|---|---|---|---|
| 0 | 0 | 0 | 0 | 0 |
| 0 | 0 | 1 | 0 | 1 |
| 0 | 1 | 0 | 1 | 1 |
| 0 | 1 | 1 | 1 | 0 |
| 1 | 0 | 0 | 1 | 1 |
| 1 | 0 | 1 | 1 | 0 |
| 1 | 1 | 0 | 0 | 0 |
| 1 | 1 | 1 | 0 | 1 |

Exclusive OR is a bitwise operation; it acts on one bit. Since a byte is merely a collection of eight bits, one can perform an XOR of two bytes by doing eight bitwise operations at the same time. The same aggregation allows an XOR to be performed on any number of bytes. So if one is talking about three data disks (A, B, and C) and their parity disk P, one can say that AˆBˆC=P and, if disk A fails, A=PˆBˆC. In this manner, data on disk A can be recovered.

### SUMMARY

The present invention discloses a method and system for efficiently writing data to a RAID. A method for writing data to a RAID includes the steps of writing an entire slice to the RAID at one time, wherein a slice is a portion of the data to be written to each disk in the RAID; and maintaining information in the RAID for the slices that have been written to disk.

A system for writing data to a RAID includes a buffer, a parity generating device, transfer means, and a metadata portion in the RAID. The buffer is configured to receive data from a host and configured to accumulate data until a complete slice is accumulated, wherein a slice is a portion of the data to be written to each disk in the RAID. The parity generating device is configured to read data from the buffer and to generate parity based on the read data. The transfer means is used to transfer data from the buffer and the generated parity to the disks of the RAID. The metadata portion is configured to store information for slices that have been written to disk.

A computer-readable storage medium containing a set of instructions for a general purpose computer, the set of instructions including a writing code segment for writing an entire slice to a RAID at one time, wherein a slice is a portion of the data to be written to each disk in the RAID; and a maintaining code segment for maintaining information in the RAID for the slices that have been written to disk.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIG. 1 is a diagram of a virtual tape library system;

FIG. 2 is a diagram of VTL memory buffering;

FIG. 3 is a diagram of a RAID4 system with striping and a parity disk;

FIG. 4 is a flowchart of a method for generating a parity disk in a RAID4 system;

FIG. 5 is a diagram of a RAID4 system with striping, a parity disk, and mirror pairs;

FIG. 6 is a diagram of RAID memory buffering; and

FIG. 7 is a flowchart of a method for writing data to a RAID and generating parity for the RAID.

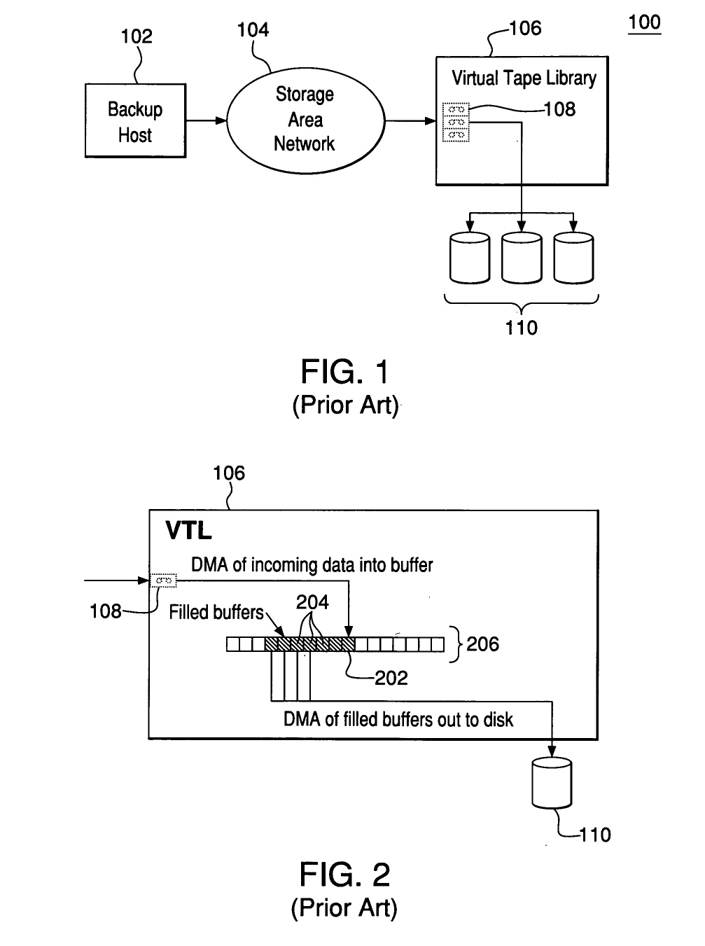

### DETAILED DESCRIPTION OF THE PREFERRED EMBODIMENTS

Improved Parity Generation

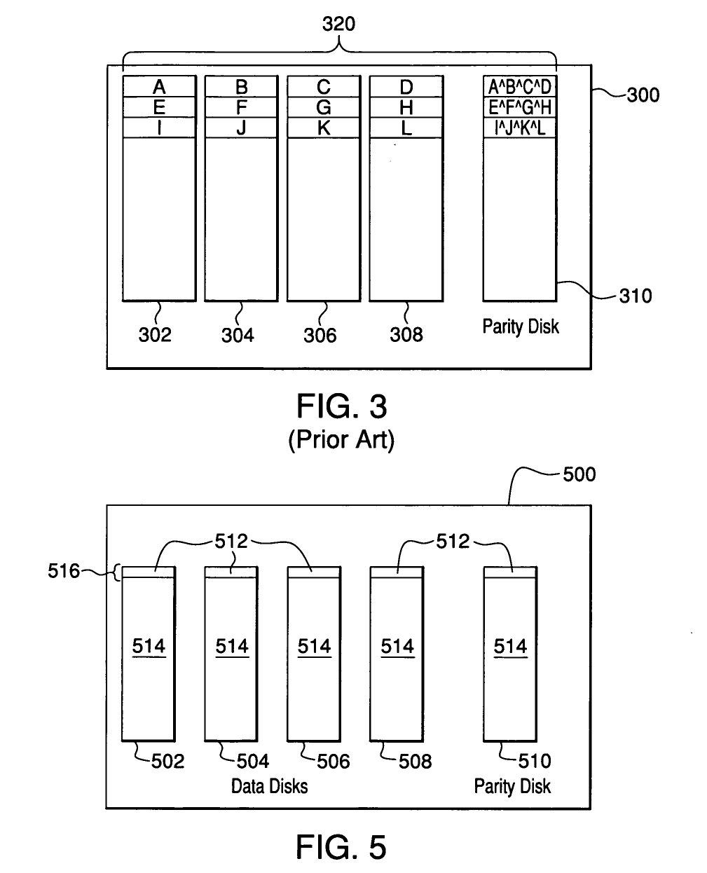

In a general purpose RAID such as the one shown in FIG. 3, if stripe C on disk 306 is written to, then the parity disk 310 needs to be updated. The parity could be updated by reading stripes A, B, and D; generating the new parity with stripe C's new data (such that the parity is old A ˆ old B ˆ new C ˆ old D); and then writing both stripe C and the parity disk 310. This would require three write operations to generate the parity. It should be noted that while the XOR logical operation is described herein as being used to generate the parity, any other suitable logical operation could be used.

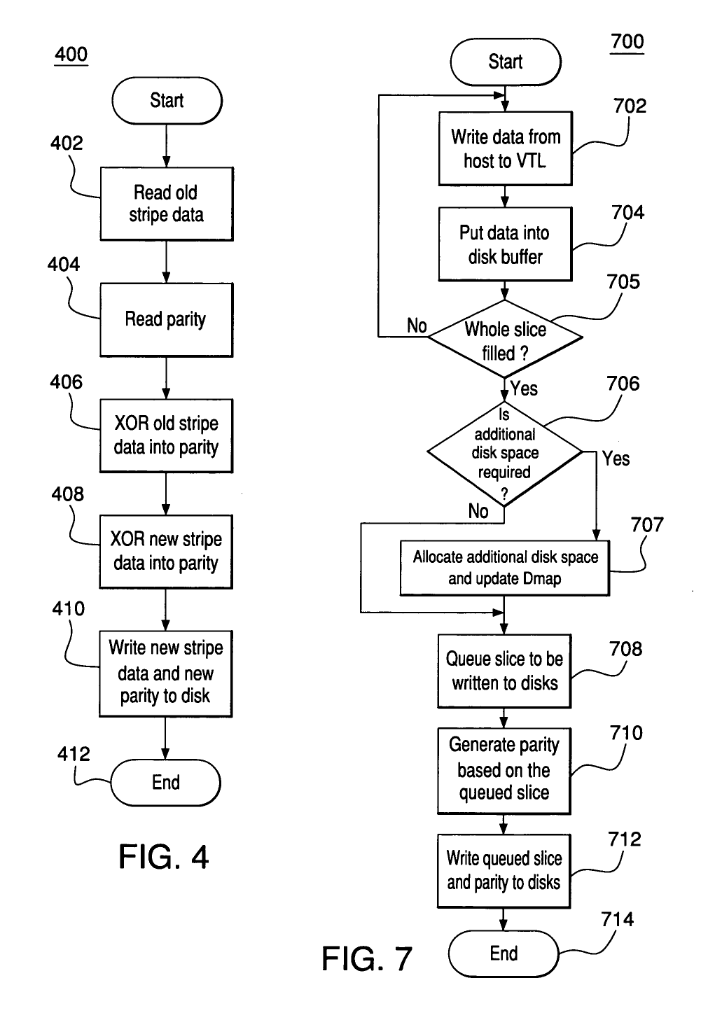

A more efficient way to generate the parity is to use the method 400 shown in FIG. 4. First, the old stripe data (stripe C in this example) is read (step 402) and the parity is read (step 404). The old stripe data (stripe C) is XOR'ed into the parity to remove the old stripe data (step 406). The new stripe data (for stripe C) is XOR'ed into the parity to add the new stripe data (step 408). The new stripe data and the new parity are written to disk (step 410) and the method terminates (step 412). The method 400 uses two reads (old stripe C and the parity) instead of three reads (old stripes A, B, and C). Additionally, the method 400 would still only require two reads if there were ten data disks. By reducing the number of reads, the method 400 executes quickly.

To be able to use stripe C and the value AˆBˆCˆD from the parity disk to modify parity efficiently, the parity disk has to have the value AˆBˆCˆD on it before the write to stripe C is performed. This means that the parity disk has to be initialized when the RAID is defined and added to the system. There are two ways initialize the parity disk: (1) read the disks and generate the parity, or (2) write the data disks with a known pattern and the parity of that pattern to the parity disk. Both of these initialization procedures require a relatively long time to complete.

Sparse RAID4

FIG. 5 is a diagram of a Sparse RAID4 system 500. A sparse RAID is a RAID that is not full or that has “holes” in it, meaning that the filled regions are not contiguous. The system 500 includes a plurality of data disks 502, 504, 506, 508 and a parity disk 510. Each disk 502-510 includes a mirrored section 512 and a RAID4 region 514. While the system 500 is described as a RAID4 system, the present invention is applicable to any type of RAID system (e.g., a RAID5 system) or storage system.

The VTL has two types of data that it records to disk: large amounts of user data written to disk sequentially and a small amount of metadata (a few percent of the total) written randomly. Rather than try to use the same type of RAID to handle both types of data, one aspect of the present invention separates the disks into two parts: a small mirrored section 512 for the metadata and a large RAID4 region 514 for the user data. The mirrored sections 512 are then striped together to form a single logical space 516 for metadata. As used hereinafter, the term “metadata portion” refers to both the mirrored sections 512 individually and the single logical space 516.

As aforementioned, data maps (Dmaps) keep track of the sequence of allocation units (or additional disk space), assigned to each stream. These Dmaps are part of the metadata that is stored. It should be noted that other types of metadata may be stored without departing from the spirit and scope of the present invention. For example, the metadata may also include information stored by the aforementioned virtual tape volume (VTV) which records the record and file marks as well as the amount of user data. The metadata can be used to improve recovery performance in the event of a disk failure. Since the metadata tracks the slices that have been written to disk, the recovery can be improved by only recovering those slices that have been previously written to disk. In an alternate embodiment, the metadata can be used to track which slices have not yet been written to disk.

In the RAID4 region 514, the allocation units tracked by the data maps are adjusted to be a multiple of the slice size. Since this data is recorded in large sequential blocks, the read-modify-write behavior of a generic RAID4 can be avoided. Each new sequence of writes from the backup host starts recording at the beginning of an empty slice. Once an entire slice of data has been accumulated, the parity is generated, and the individual stripes in the slice are queued to be written to the disks.

Memory Buffering

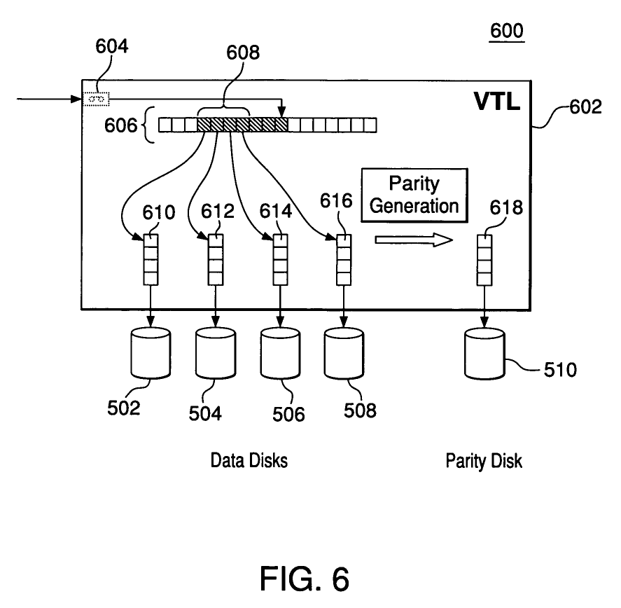

FIG. 6 is a diagram of a RAID system 600 configured to perform memory buffering. Data is written from a host to a VTL 602 and to a particular virtual tape drive 604. The data is placed into a buffer 606 and is arranged into a slice 608. Once the slice 608 is filled, the data is transferred in stripes to buffers 610, 612, 614, 616 for the disks 502-508. The stripe size in a preferred RAID4 implementation is 128 KB to match the 128 KB segment size used for buffering. After the data is transferred to the buffers 610-616, the parity for the entire slice 608 is generated and placed into a buffer 618 for the parity disk 510. The writes from the buffers 610-618 to the disks 502-510 are performed when the buffers are flushed.

In an alternate embodiment, which can be used when the system is low on memory, the first stripe is written to disk and its buffer becomes the parity buffer. Subsequent stripe buffers are XOR'ed into that buffer until the entire slice is processed, and then the parity buffer is written out to disk.

FIG. 7 is a flowchart of a method 700 for writing data to a RAID and generating parity for the RAID, using the system 600. Data is written from the host to the VTL (step 702). The data in the VTL is placed into a disk buffer (step 704). A determination is made whether an entire slice has been filled by examining all of the disk buffers (step 706). If an entire slice has not been filled, then more data is written from the host to fill the slice (steps 702 and 704).

If an entire slice has been filled (step 705), the current allocation unit is used to determine where on the disk to store the slice. If it is determined 706 that the current allocation unit is full, additional space is allocated and the Dmap is updated (707) in the metadata portion. The slice is then queued to be written to the disks of the RAID (step 708). If the current allocation unit is not full and additional disk space is not required, step 707 is bypassed. Queuing the data for each stripe is a logical operation; no copying is performed. The parity is generated based on the data in the queued slice (step 710). Once the parity has been generated, and the slice has been written successfully to disk, (or is otherwise made persistent), the slice is considered to be valid. In a preferred embodiment, there is one parity buffer per slice, which improves performance by eliminating the need to read from the disks to generate the parity. The memory used for data transfer is organized as a large number of 128 KB buffers. The stripes can be aligned to the buffer boundaries to simplify the parity generation by avoiding having to handle multiple memory segments in a single stripe. The queued slice and the parity are written to disks (step 712) and the method terminates (step 714). To maintain good disk performance, writes to the disk are issued for four queued segments at a time.

It should be noted that while the preferred embodiment stores the information about which slices are valid in the metadata portion of the RAID, this does not preclude storing that information anywhere within the RAID system 600.

Since there is no read-modify-write behavior, the parity disk 510 does not need to be initialized in advance, which saves time when the RAID is created. Due to the management by the VTL, a valid parity stripe is only expected for slices that have been validly written to disk. The parity will be valid only for the slices 608 that have been filled with user data and those slices 608 are part of the allocation units that the data maps track for each virtual tape.

Any errors in writing the parity disk or the data disks invalidates that slice. An example of a failed write operation is as follows: data is written to stripes A, B, and C successfully and the write to stripe D fails. Because the tracking is performed at the slice level, and not at the stripe level, if the write to stripe D fails, a failure for the slice is indicated since it is not possible to determine which stripe within the slice has failed. If tracking is performed at the stripe level, then it would be possible to reconstruct stripe D from the remainder of the slice.

If one of the disks fails during the write of the slice, the system is in the same degraded state for that slice as it would be for all of the preceding slices and that slice could be considered successful. In general, it is better for the VTL to report the write failure to the backup application if the data is now one disk failure away from being lost. That will generally cause the backup application to retry the entire backup on another “tape” and the data can be written to a different, undegraded RAID group.

Verifying and Recovering RAID Data

It may be necessary to verify the data in the RAID on a periodic basis, to ensure the integrity of the disks. To perform a verification, all of the data stripes in a slice are read, and the parity is generated. Then the parity stripe is read from disk and compared to the generated parity. The slice is verified if the generated parity and the read parity stripe match. In a sparse RAID, only those slices that have been successfully written to disk need to be verified. Since the entire RAID does not need to be verified, this operation can be quickly performed in a sparse RAID.

If a disk fails, the data that was on the failed disk can be reconstructed, via a recovery operation. The recovery operation is performed in a similar manner to a verification. As in a verification, only the slices that contain successfully written data need to be recovered, since only those slices are tracked through the VTL. The information from the data maps is used to identify the slices that need to be reconstructed. Since the data map is a “consumer” of space on the disk, the partial reconstruction is referred to as “consumer driven.” The benefit of reconstructing only the portions of the RAID that might have useful data varies depending on how full the RAID is. The time savings is more pronounced when less of the RAID is used, because there is less data to recover. As the RAID approaches being full, the time savings are not as significant.

While specific embodiments of the present invention have been shown and described, many modifications and variations could be made by one skilled in the art without departing from the scope of the invention. For example, a preferred embodiment of the present invention uses a RAID4 system, but the principles of the invention are applicable to other multi-volume data storage systems, such as other RAID methodologies or systems (e.g., RAID5). The above description serves to illustrate and not limit the particular invention in any way.

What is claimed is:

1. A method for writing data to a redundant array of inexpensive disks (RAID), comprising the steps of:
writing an entire slice to the RAID at one time, wherein a slice is a portion of the data to be written to each disk in the RAID; and
maintaining information in the RAID for the slices that have been written to disk.

2. The method according to claim 1, wherein the maintained information is used to improve recovery performance in the event of a disk failure.

3. The method according to claim 2, wherein the recovery performance is improved by only recovering those slices that have previously been written to disk.

4. The method according to claim 1, wherein the maintained information is used to track which slices have been written to disk.

5. The method according to claim 1, further comprising the step of:
aggregating the maintained information for each slice into a single disk portion in the RAID.

6. The method according to claim 1, wherein the maintaining step includes maintaining information for the slices that have not been written to disk.

7. The method according to claim 6, wherein the maintained information is used to track which slices have not been written to disk.

8. A system for writing data to a redundant array of inexpensive disks (RAID), comprising:
a buffer, configured to receive data from a host and configured to accumulate data until a complete slice is accumulated, wherein a slice is a portion of the data to be written to each disk in the RAID;
a parity generating device, configured to read data from said buffer and to generate parity based on the read data;
transfer means for transferring data from said buffer and the generated parity to the disks of the RAID; and
a metadata portion in the RAID, said metadata portion configured to store information for slices that have been written to disk.

9. The system according to claim 8, wherein said transfer means includes direct memory access to transfer the data from said buffer and the generated parity to the disks of the RAID.

10. The system according to claim 8, further comprising:
a plurality of buffers for accumulating data, one buffer associated with one disk of the RAID.

11. The system according to claim 10, wherein said transfer means transfers data from each of said plurality of buffers when a complete slice has been accumulated.

12. The system according to claim 8, wherein said transfer means transfers data to disk while said parity generating device is generating the parity for the data.

13. The system according to claim 8, wherein said metadata portion is configured to store information for slices that have not been written to disk.

14. A computer-readable storage medium containing a set of instructions for a general purpose computer, the set of instructions comprising:
a writing code segment for writing an entire slice to a redundant array of inexpensive disks (RAID) at one time, wherein a slice is a portion of the data to be written to each disk in the RAID; and
a maintaining code segment for maintaining information in the RAID for the slices that have been written to disk.

15. The storage medium according to claim 14, wherein said maintaining code segment includes a recovery code segment for improving recovery performance in the event of a disk failure.

16. The storage medium according to claim 15, wherein said recovery code segment improves recovery performance by only recovering those slices that have previously been written to disk.

17. The storage medium according to claim 14, wherein said maintaining code segment includes a tracking code segment for tracking which slices have been written to disk.

18. The storage medium according to claim 14, wherein the set of instructions further comprises:
an aggregating code segment for aggregating the maintained information for each slice into a single disk portion in the RAID.

19. The storage medium according to claim 14, wherein said maintaining code segment includes a tracking code segment for tracking which slices have not been written to disk.
